(19) United States
(12) Patent Application Publication
(10) Pub. No.: US 2010/0044023 A1
(43) Pub. Date: Feb. 25, 2010

(54) Heat exchanger systems & fabrication methods

(76) Inventors: Andres Alberto Canales, Houston, TX (US); Lendell Martin, SR., Houston, TX (US)

Correspondence Address: Guy McClung, # 114, 5315-B F.M. 1960 Rd. West, Houston, TX, 77069-4410, US

(21) Appl. No.: 12/229,309

(22) Filed: Aug. 21, 2008

(51) Int. Cl. F28F 9/04; B23P 15/26

(52) U.S. Cl. 165/178; 29/890.047

(57) ABSTRACT

A heat exchanger with multiple tubes whose ends are connected with connectors to provide a flow path for heat exchange fluid through the heat exchanger. This Abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### BACKGROUND OF THE INVENTION

1. Field of the Invention

This present invention is directed to heat exchanger systems, to methods for making heat exchangers, and, in certain particular aspects, to methods for joining U-bend connectors to ends of adjacent heat exchange tubes.

2. Description of Related Art

The prior art discloses a wide variety of heat exchangers, methods for making them, and methods for connecting ends of adjacent heat exchanged tubes including, but not limited to, the disclosures in U.S. Pat. Nos. 3,750,248; 3,877,519; 4,502,532; and 5,211,221 all incorporated fully herein for all purposes.

U.S. Pat. No. 3,750,248 discloses method of making a refrigeration evaporator or condenser construction wherein the ends of preferably aluminum tubes which have been extended through heat exchange plates or fins in a refrigeration evaporator or condenser construction are joined with U-bend connectors, the method comprising forming radial internal beads near the ends of the tubes to be connected to provide stops for the ends of the U-bend connectors which are of lesser diameter, flaring the very end portions of the tubes to be connected, laying a thermo-fluid welding material around the connector end portions within the flared ends of the tubes to be connected, and applying heat to flow the material prior to chilling. In one aspect, a method is disclosed for making an evaporator or condenser construction for refrigeration apparatus, the method including the steps of providing at least two elongated main metal tubes defining a plurality of main tube ends, each of the main tubes having substantially uniform inside and outside diameters throughout the length thereof and having a mill stock finish, providing at least one generally U-shaped connector tube having substantially uniform inside and outside diameters throughout the length thereof and a mill stock finish and defining a pair of connector tube ends, the main tube ends and the connector tube ends having such relative inside and outside diameters that the U-shaped connector tube may have each of its two tube ends telescopically assembled with an associated one of the main tube ends to form a connection consisting of two joints each involving one tube end inserted in another tube end, thrusting the main tubes through heat exchanged plates and in general parallel relation, forming only a radially inwardly directed bead on the larger diameter tube end of each proposed joint and which bead is spaced from the adjacent open end of the larger diameter tube end to define a socket between the open end and the bead, the socket having an inside diameter equal to the inside diameter of the remainder of the tube in which it is formed and an interior surface having a mill stock finish, assembling each tube end of the connector tube telescopically with an associated one of the pair of the pair of main tube ends to bring the smaller diameter tube end of each joint into abutting relation with an associated bead, applying a solder bonding material around each end portion of the smaller diameter tube end of each joint and generally adjacent the open end of the larger diameter tube end of each joint, heating each joint to cause the bonding material to flow and thereby to run it into any space between the end portion of each tube to be connected and the associated end portion of the end of the connector tube and cooling each joint to achieve fluid type solidification of the bonding material.

U.S. Pat. No. 3,877,519 discloses aluminum tubes particularly useful in forming heat exchange coils joined together by first flaring and necking respective tube ends to define tapered mating surfaces to insure maximum wetting of both surfaces by the epoxy which bonds the tubes together when the epoxy coated male tube is inserted axially within the female tube. In one aspect a heat exchange coil is disclosed of the type including a plurality of adjacently positioned first hairpin shaped aluminum tubes carrying internally, a high pressure fluid, and being commonly supported by a plurality of longitudinally spaced heat exchange fins with the straight portions of the tubes extending through holes within the fins and with the ends of two separate tubes being joined by a second, U-shaped return bend aluminum tube, the ends of one of the tubes flared and the ends of the other tubes necked to define axially opposed tapered mating surfaces, and wherein the tubes are coupled together solely by a uniform thickness epoxy adhesive between the mating surfaces to complete a high integrity, fluid seal bond therebetween of sufficient strength to prevent longitudinal separation of the return bend tube from the straight portions of the tubes joined thereto due to the high fluid pressure acting directly on the return bend tube and creating a resultant force tending to longitudinally separate the return bend tube from the hairpin tubes.

U.S. Pat. No. 4,502,532 discloses a joint construction for a fin-and-tube type heat exchanger formed of aluminum suitable for use as an evaporator of a cooling system for an automotive vehicle, wherein an end plate near the open ends of tubes is formed with openings larger in diameter than the openings formed in fins to which the tubes are securedly fixed. The joint construction includes a flare formed at the open end of the tube by inserting a tube end flaring punch and restrained by the opening formed in the end plate to be kept from outwardly expanding more than is necessary. Thus the flare produced has high dimensional accuracy and a tube member can be joined to the open end of each tube by brazing with a high degree of accuracy and precision. The brazed joint produced has higher reliability in performance than brazed joints of the prior art. The use of the improved joint construction enables brazing to be carried out automatically and allows a compact size to be obtained in a fin-and-tube type heat exchanger. In one aspect, a joint construction is disclosed of a fin-and-tube type heat exchanger with an upper end plate, a lower end plate, a plurality of fins disposed in a superposed relationship in layers between the upper end plate and the lower end plate, a plurality of tubes which may be either straight or bent in a U-shaped form, and a plurality of tube members each connected to one of the plurality of tubes at open ends thereof, the plurality of tubes are inserted in openings formed in the upper and lower end plates and fins and are expanded so as to bring the tubes into intimate contact with the fins and securedly clamp them together, each of the tube members is joined to one of the plurality of tubes at the end, each of the tubes project beyond an upper surface of the upper end plate and are formed with a flared portion, each of the tubes includes a straight portion which is expanded for securely fixing the same to the upper end plate and an inner surface fitted to the outside of the tube members in the upper end plate, the ends of the tube members are inserted in the straight portions of the tubes and portions between the tube members and a lower inside portion of the flared portions are braze jointed.

U.S. Pat. No. 5,211,221 discloses method and apparatuses for joining coolant tubes of a heat exchanger. In one aspect, a joint is disclosed and a method for making a joint for interconnecting various segments of coolant tubes of heat exchangers. In one aspect, the joint including a first tube having a necked end with a reduced outer diameter and a second tube having a frustro-conical portion with a steadily increasing inner diameter. The necked end of the first tube is inserted within the frustro-conical portion of the second tube thus forming a frustro-conical portion shaped increasing gap space therebetween. The increasing gap space is filled with epoxy adhesive to form a bond of steadily increasing thickness between the outer diameter of the first tube and the steadily increasing inner diameter of the frustro-conical portion of the second tube). In one aspect, a joint is disclosed for joining coolant tubes of a heat exchanger, the joint including: a first tube having an outer diameter; a second tube having an inner diameter, a frustro-conical portion, and a flared extremity; the frustro-conical portion tapering steadily outward from the inner diameter to the flared extremity and forming a steadily increasing inner diameter extending from the inner diameter to the flared extremity; the flared extremity flaring steadily outward from the frustro-conical portion and defining a frustro-conical access; a first portion of the first tube disposed within the second tube and forming a surface contact between the outer diameter of the first tube and the steadily increasing inner diameter of the frustro-conical portion, and a second portion of the first tube extending out from the second tube; a steadily increasing gap space formed between the outer diameter of the first tube and the steadily increasing inner diameter of the frustro-conical portion of the second tube; the gap space extending directly from the surface contact and steadily increasing in thickness to a position adjacent the flared extremity, the a frustro-conical access extending from the flared extremity directly to the surface contact; organic polymeric material disposed through the frustro-conical access and into the increasing gap space to form a bond of steadily increasing thickness between the outer diameter of the first tube and the steadily increasing inner diameter of the frustro-conical portion of the second tube; and the bond extending from the surface contact between the increasing inner diameter of the frustro-conical portion of the second tube and the outer diameter of the first tube and steadily increasing in thickness to a position adjacent the flared extremity thereby ensuring the formation of a bond of optimum thickness between the first and second tubes.

Without being held to any particular theory, the present inventors believe that air gap problems in tube heat exchangers are related to air gaps between tube materials that act as an insulator. It can be difficult to heat both tubes and materials uniformly with a single point heat source under certain time constraints, often causing a large temperature difference between materials of both tubes. Temperature dependent bonding material, such as solder or adhesives, can be difficult to fill or distribute into a material connection due to a temperature difference between materials resulting from a single point heat source. Also, melting points of solder may be exceeded or not achieved due to non-uniform temperatures in each of two tubes. Melted solder bonds effectively to one material at a correct temperature and often only “covers” another material that is not at the required temperature (often resulting in an unacceptable bond).

Certain adhesives that are temperature dependent need to be at a certain temperature to create viscosities that allow the material to flow easily in small spaces, such as gaps between two materials of tubes to be bonded. Material that is not at the required temperature will impede the flow of adhesive and will not allow it to cover the entire surface of the “not-to-temperature-material” in the allotted time. Overheating of one material to decrease the time it takes the other material to reach a necessary temperature can cause the heated material to become damaged or reach a melting point. This overheating can also change the tube's mechanical properties, potentially making the tube weaker (less stress/strain tolerance) and allowing it to fail under pressurized conditions. Overheating can also cause unnecessary expanding of the tube material that will further create stresses when the material retracts as it cools. This can also cause another problem in which the gap between two tubes becomes larger and more bonding material is necessary to fill the gap.

When air gaps are present in tube material connections, a single point heat source may not be sufficient to heat both parts in a certain amount of time, and, therefore, a second heat source is used or the single point heat source is moved between both tubes to increase the temperature at a near-identical rate and uniform temperature. Using a second heat source or employing more time with a single heat source may require more electricity, more combustible gas, more labor and/or more material to create a necessary temperature between both parts. This can directly affect the final cost of producing such connections. Air gaps also have another potential problem when using a combustible heat source such as a flame or torch. The more air present in a gap, the more air that can hold contaminates that will develop or impede bonding during a heating process. These contaminates can cause pitting, accelerated corrosion, surface forming buildup or act as more insulation.

Heat transfer rate for two similar material thicknesses of the same material are nearly identical, even when they are different shapes. The heat transfer rate of two different materials of the same thickness will be different (i.e. copper and aluminum). For example, aluminum has a lower heat transfer rate than copper when they have the same wall thickness.

### BRIEF SUMMARY OF THE INVENTION

The present invention discloses, in certain aspects, novel heat exchangers and methods for joining U-bend connectors to adjacent ends of adjacent heat exchange fluid transfer tubes in a heat exchanger. In certain aspects, ends of heat exchange tubes are not expanded and U-bend connectors are used which have a smaller outer diameter than the inner diameter of tube ends into which the U-bend connector ends are placed.

In one aspect, in methods according to the present invention, less connection material (e.g. solder, brazing material or welding material) is needed to form an effective sealed joint between ends of a U-bend connector and tube ends of fluid flow tubes of a heat exchanger. Using less connection material and not having to expand the tube ends results in a less expensive, less labor intensive, less time consuming method of fabrication of a heat exchanger.

In certain aspects methods according to the present invention result in less distortion of fluid flow tubes' ends and less damage to these ends because less heat is required to form an effective connection and, without the expanded tube end area, more efficient heat transfer is accomplished between the tube ends and the U-bend ends during heating; i.e., the U-bend ends can act as more efficient heat sinks during heating of the tube ends since there is less chance of the formation of insulating air gaps in the connection according to the present invention compared to the prior art methods in which the area of the expanded tube ends is relatively large and difficult to fill completely with connection material.

The present invention, in at least certain aspects, discloses a heat exchanger with a plurality of tubes, each tube of the plurality of tubes comprising a heat exchange tube, the tubes adjacent each other, each tube in fluid communication with at least one adjacent tube so that heat exchange fluid is flowable through all the tubes; a plurality of heat exchange fins connected to the plurality of tubes; each tube of the plurality of tubes having an inlet with an inlet end and an outlet with an outlet end; a plurality of connectors, each pair of adjacent tubes comprising a first tube and a second tube and a connector connecting the outlet of the first tube to the inlet of the adjacent second tube providing fluid communication between the first tube and the second tube; the inlet end and outlet end of each tube comprising a substantially straight tube portion of substantially constant inner diameter and of substantially constant outer diameter, the inner diameters of the inlet end and the outlet ends substantially equal; each connector having a first end sealingly secured within the outlet end of its corresponding first tube and a second end sealingly secured within the inlet end of its corresponding second tube; and each connector having an outer diameter less than the inner diameter of the tubes' inlet ends and less than the inner diameter of the tubes' outlet ends. In certain aspects, the connector wall thickness is substantially equal to the tube wall thickness or the connector wall thickness is greater than the tube wall thickness.

Accordingly, the present invention includes features and advantages which are designed to enable it to advance heat exchanger technology. Characteristics and advantages of the present invention described above and additional features and benefits will be readily apparent to those skilled in the art upon consideration of the following detailed description of preferred embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain preferred embodiments of the present invention to provide new, useful, unique, efficient, nonobvious heat exchangers, methods for making them, and methods for connecting adjacent ends of heat exchange tubes with U-bend connectors.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention or of the claims in any way.

It will be understood that the various embodiments of the present invention may include one, some, or all of the disclosed, described, and/or enumerated improvements and/or technical advantages and/or elements in claims to this invention.

Certain aspects, certain embodiments, and certain preferable features of the invention are set out herein. Any combination of aspects or features shown in any aspect or embodiment can be used except where such aspects or features are mutually exclusive.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1A is a perspective view of a prior art heat exchanger.

FIG. 1B is an exploded view of parts of the heat exchanger of FIG. 1A.

FIG. 1C is a perspective view of part of the heat exchanger of FIG. 1A.

FIG. 1D is a cross-section view of the part shown in FIG. 1C.

FIG. 1E is a schematic view of a prior art method for connecting the parts shown in FIG. 1B.

FIG. 2 is a perspective view of a heat exchanger according to the present invention.

FIG. 3A is an exploded view of two parts of the heat exchanger of FIG. 2.

FIG. 3B is a perspective view of parts of the heat exchanger of FIG. 2.

FIG. 3C is a cross-section view of the parts of FIG. 3B.

FIG. 4 is a schematic view of a method according to the present invention for connecting parts of a heat exchanger.

FIG. 5 is a cross-section view of a prior art connection of a U-bend connector to a heat exchange tube.

FIG. 6 is a cross-section view of a connection according to the present invention of a U-bend connector to a heat exchange tube.

FIG. 7 is a cross-section view of a connection according to the present invention between a U-bend connector and ends of adjacent heat exchange tubes.

Presently preferred embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. In showing and describing the preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein.

### DETAILED DESCRIPTION OF THE INVENTION

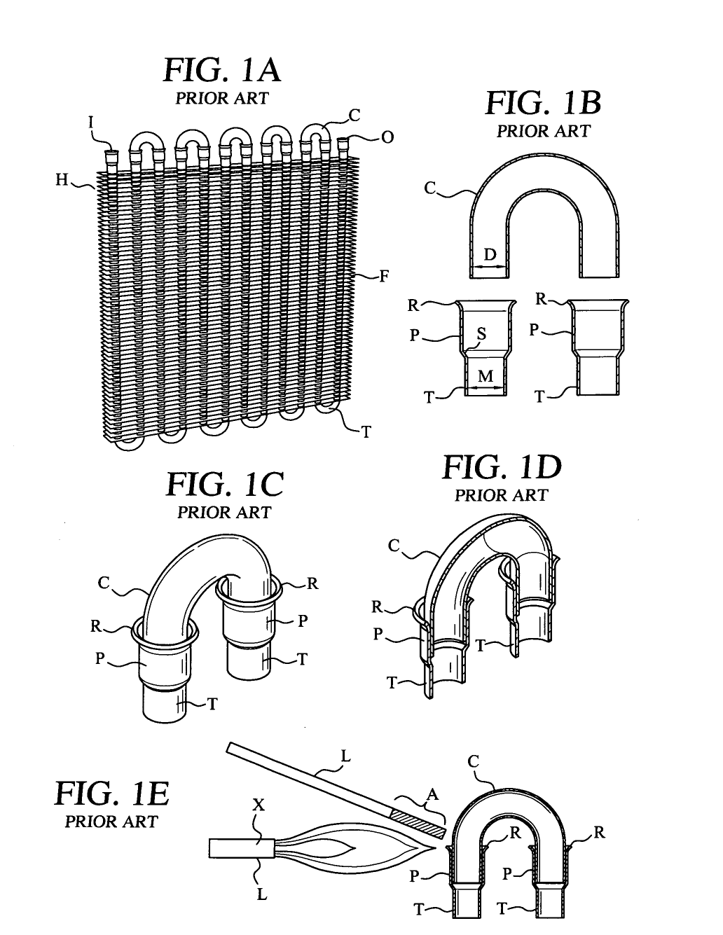

FIG. 1A shows a prior art heat exchanger H with tubes T through which heat exchange fluid flows and fins F in contact with the tubes T. Connectors C (“U-bend connectors”) connect adjacent ends of adjacent tubes T so that fluid is flowable from an inlet I to an outlet O through all the tubes T and the connectors C.

As shown in the FIGS. 1A-1E, each end of a tube T projecting from the upper most fin F has a flared portion R and an expanded portion P. In one aspect of prior art heat exchangers and, as shown in FIG. 1B, an inner diameter D of a connector C is substantially the same as the inner diameter M of the tubes T. To accommodate the outer diameter of the connectors C, the expanded portion P must be sufficiently wide to receive an end of a connector C. Expanding a tube end can result in stress that damages the tube end.

The flared portion R facilitates the initial entry of an end of a connector C into the expanded portion P. The ends of the connector C go down into ends of tubes T until the ends of the connectors C abut a lowermost shoulder S of the expanded portion P of the ends of the tubes T. Thus the shoulders S serve as stops for the ends of the connectors C.

As shown in FIG. 1E in a prior art method for securing the connectors C to the tubes T, heat, e.g. from a torch X, or other heater or heat source, is applied to the ends of the tubes T and solder L (connection material, brazing material, or welding material) melts and flows down into the expanded portion P of the ends of the tubes T. A number of problems may be associated with this method. Often the ends of the tubes T are heated so much that they are warped or damaged. Also, to fill the space within the expanded portion P, a relatively large amount of solder (or other material) is required. This is illustrated schematically by a cross-hatched amount A of the solder L. It is also possible for an insulating air gap to develop between the interior of the expanded portion P and the exterior of the connector ends within the expanded portion P. Such an air gap can necessitate the application of higher heat to the tube ends which can result in warping of or damage to the tube ends.

The tubes and the connectors can be made from the same material, e.g. copper, steel, stainless steel, or aluminum Problems with the application of sufficient heat rather than too much heat can be exacerbated when certain materials are used for the tubes T and the connectors C; e.g., when the tubes T are copper and the connectors are aluminum (or vice-versa); or when both tubes T and connectors C are copper or aluminum.

As shown in FIG. 1B, in certain prior systems, the wall thickness of a connector C is substantially equal to the wall thickness of the tubes T.

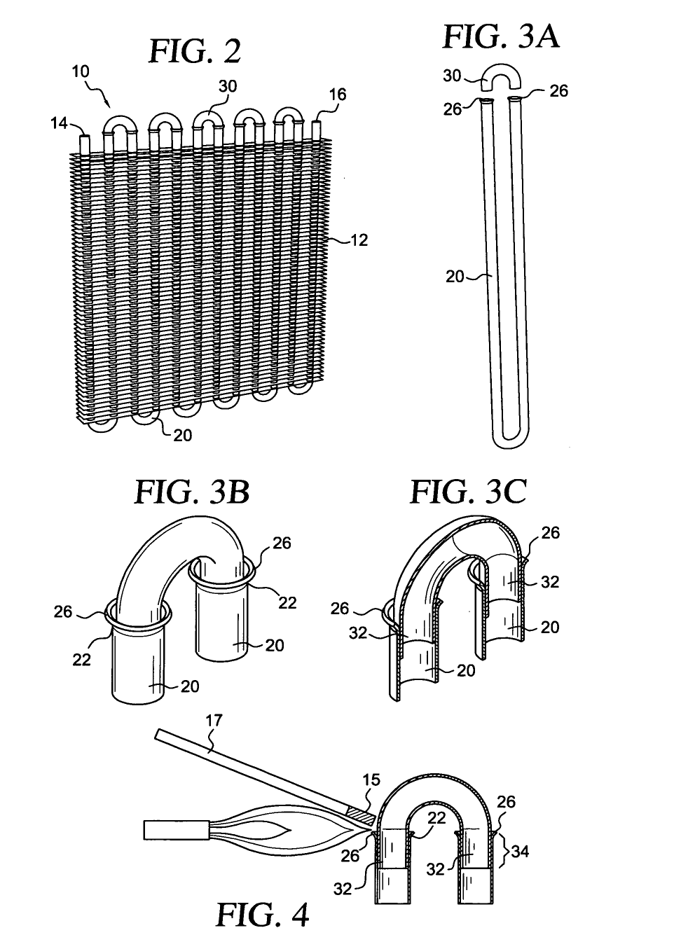

FIG. 2 illustrates a heat exchanger 10 according to the present invention which has a plurality of spaced-apart fins 12 mounted on a plurality of spaced-apart heat exchange tubes 20 through which heat exchange fluid flows. The heat exchange fluid enters the system 10 at an inlet 14 at one end of a heat exchange tube 20 and exits from an outlet 16 at another end of a heat exchange tube 20.

Connectors 30 (“U-bend connectors”) connect adjacent ends of adjacent tubes 20 so that a continuous fluid flow path exists from the inlet 14 to the outlet 16.

As shown in FIGS. 2, 3A-3C and 4, ends 22 of the tubes 20 are, optionally, flared (flared portions 26) to facilitate entry of ends 32 of the connectors 30 into ends 22 of the heat exchange tubes 20. As shown in FIGS. 3C and 4, the outer diameter of the connection ends 32 is less than the inner diameter of the tube ends 22. In certain aspects, this difference is small enough that the connector ends 32 fit tightly into the tube ends 22 without distortion of the connector ends 32.

It is also within the scope of the present invention for the wall thickness of the connectors 30 to be larger than the wall thickness of the tube ends 22 of adjacent heat exchange tubes. This is illustrated by the connector 30a and the tube ends 22a, 22b in FIG. 7.

In one aspect, the curved portions of the connectors 30 above the connector ends 32 come to abut a top of the ends 22 to stop further passage of the ends 32 into the ends 22. In one aspect, the connectors 30 are sized and configured so that a sufficient length 34 of each connector end 32 extends down into the tube ends 22 to provide heat sink protection in the ends 22 where the ends 22 are heated to secure the connectors 30 in place. Optionally, impressing the ends 32 into the ends 22 to a sufficient depth suffices for a good joint, whether the curved portions abut the ends 22 or not.

FIG. 4 illustrates a method according to the present invention for securing the ends 32 in the ends 22. A flame is applied to the ends 22 and solder 17 (or other material) is applied down into the flared portions 26. In one aspect the solder (or other material) substantially encompasses the ends 32 down within the ends 22 (and substantially fills any gap between the interior of the tubes and the exterior of the connector ends) to effectively secure the ends 32 within the ends 22. In one aspect, only an amount 15 of the solder is needed to effectively and sealingly secure the ends 32 in the ends 22 (an amount meant to compare favorable to the relatively larger amount of solder indicated by the cross-hatched portion in FIG. 1E). In certain aspects a thin air gap between the tube ends 32 and 22 creates a capillary effect drawing solder in to fill the gap. Also, a pool of solder in a flared portion can have a pressure head that forces solder down into a gap. In certain similar cases new methods according to the present invention require about only one third of the solder previously required with old known methods.

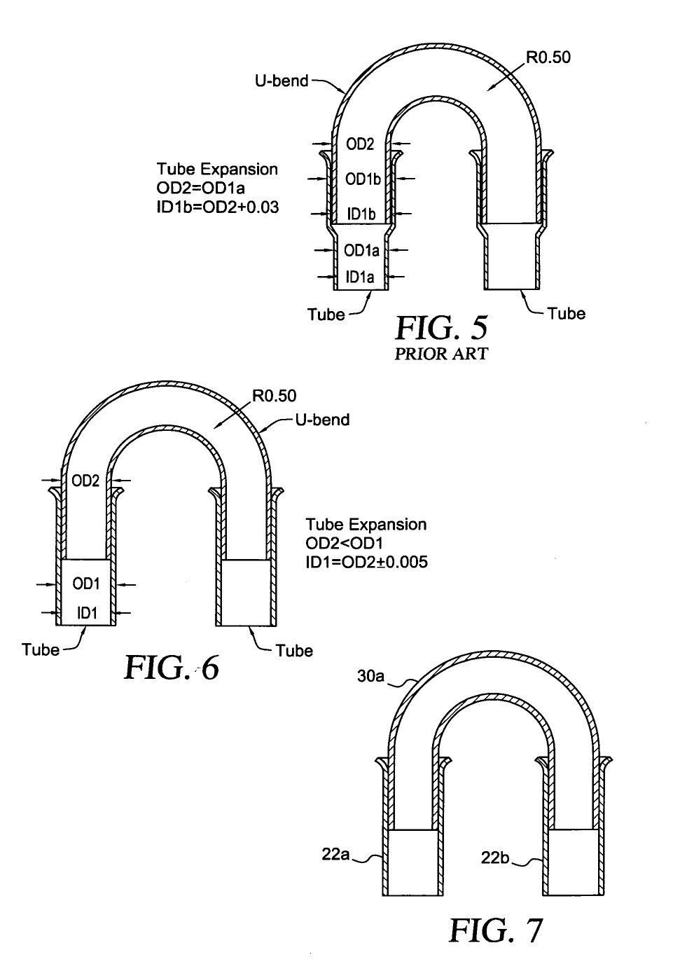

FIGS. 5 and 6 present a comparison of one prior art connection of a U-bend connector (“U-bend”) to a connection according to the present invention. The tubes in the FIG. 5 prior art connection have had their ends flared and, also, expanded (which expansion can stress the ends causing damage). The outer diameter of the U-bend connector (OD2) equals the outer diameter of the tubes and their inner diameters are equal. The inner diameter of the expanded parts of the tubes (ID1b) is larger than the outer diameter of the U-bend connectors (e.g. by about 0.03 inches). This creates a gap between the outer surface of the U-bend connector and the inner surface of the expanded parts of the tubes. For a good sealed connection, these gaps should be filled with material (e.g. solder, welding material, or brazing material). The heat required can cause warping and damage.

As shown in FIG. 6 for the connection according to the present invention, no expansion of the tube ends is required; the outer diameter of the U-bend connector (ID2) is less than the inner diameter of the tubes (ID1); and there is a tight fit between the tubes ends and the U-bend connector, i.e., e.g. the inner diameter (ID1) of the tube ends is ±0.0005 inches larger than the outer diameter of the U-bend connector ends (OD2).

In certain aspects of methods according to the present invention, the wall thickness of a U-bend can be equal to or different from to the wall thickness of a tube inserted therein. Wall thickness is a factor in the mechanical strength of the parts (and a larger wall thickness in a U-bend can reduce unwanted thinness on a radius of a U-bend). A larger wall thickness in a U-bend (compared to that of a tube) can act as a larger heat sink. Due to the volume of material between a tube with a large OD and a u-bend with a smaller OD, they can to be almost the same volume.

Heat transfer coefficients vary for different types of material (e.g. copper, aluminum, stainless steel, etc.) and therefore a ratio in wall thickness between U-bend and tube can be important for even, consistent and/or well distributed heat transfer under certain time constraints using a flame. In certain embodiments of the present invention, the ratio of cross-sectional area between a U-bend and a tube can be in the range of 25% to 250%. When the ratios are at 100%, the cross-sectional area of both tubes are the same, but the wall thickness of the smaller diameter tube is still larger. In one particular aspect, using aluminum material, the cross-sectional area ratio is about 97%, i.e., there is nearly the same cross-section for both tubes and the wall thickness of the smaller diameter tube is larger than that of the larger diameter tube; e.g. in one aspect, the wall thickness of the smaller diameter tube is about 120% larger than the larger diameter tube.

The present invention, therefore, provides in at least some embodiments, a heat exchanger with a plurality of tubes, each tube of the plurality of tubes comprising a heat exchange tube, the tubes adjacent each other, each tube in fluid communication with at least one adjacent tube so that heat exchange fluid is flowable through all the tubes; a plurality of heat exchange fins connected to the plurality of tubes; each tube of the plurality of tubes having an inlet with an inlet end and an outlet with an outlet end; a plurality of connectors, each pair of adjacent tubes comprising a first tube and a second tube and a connector connecting the outlet of the first tube to the inlet of the adjacent second tube providing fluid communication between the first tube and the second tube; the inlet end and outlet end of each tube comprising a substantially straight tube portion of substantially constant inner diameter and of substantially constant outer diameter, the inner diameters of the inlet end and the outlet ends substantially equal; each connector having a first end sealingly secured within the outlet end of its corresponding first tube and a second end sealingly secured within the inlet end of its corresponding second tube; and each connector having an outer diameter less than the inner diameter of the tubes' inlet ends and less than the inner diameter of the tubes' outlet ends. Such a system according to the present invention may have one or some (in any possible combination) of the following: wherein each inlet end and each outlet end has an end flared portion to facilitate entry therein of an end of a connector; wherein the tubes and the connectors are made of the same material; wherein the material is one of copper, steel, stainless steel, or aluminum; wherein the tubes and connectors are made of different materials; wherein the tubes mare made of copper and the connectors are made of aluminum; wherein the connectors are U-bend connectors; wherein the ends of the connectors fit tightly into the ends of the tubes without distortion of the ends of the connectors; wherein each tube has a tube wall thickness, each connector has a connector wall thickness, and the connector wall thickness is substantially equal to the tube wall thickness; wherein the each tube has a tube wall thickness, each connector has a connector wall thickness, and the connector wall thickness is greater than the tube wall thickness; wherein the connector wall thickness is about 120% larger than the tube wall thickness; wherein each end of each connector is secured within an end of a tube with flame-applied securement material; wherein the flame-applied securement material is solder; wherein the flame-applied securement material encompasses the ends of the connectors within the ends of the tubes; and/or wherein the securement material substantially fills space between the exterior of the ends of the connectors and the interior of the ends of the tubes.

The present invention, therefore, provides in at least some embodiments, a heat exchanger with a plurality of tubes comprising a first tube, at least one intermediate tube, and a last tube, each tube of the plurality of tubes comprising a heat exchange tube, the tubes adjacent each other, each tube in fluid communication with an adjacent tube or tubes so that heat exchange fluid is flowable through the first tube then through intermediate tubes to the last tube; a plurality of heat exchange fins connected to the tubes of the plurality of tubes; each tube of the plurality of tubes having an inlet end and an outlet end; a plurality of connectors, each pair of adjacent tubes connected with a connector connecting an outlet of one tube to an inlet of an adjacent tube providing fluid communication therebetween; each tube having a tube wall thickness; each connector having a connector wall thickness, and the connector wall thickness greater than the tube wall thickness.

The present invention, therefore, provides in at least some embodiments, a method for making a heat exchanger, the heat exchanger as any disclosed herein according to the present invention, the method including, for each pair of adjacent tubes of the heat exchanger, inserting a first end of each connector into an outlet of a first tube and securing the first end of the connector in the outlet of the first tube; and inserting a second end of the connector into an inlet of a second tube, the second tube adjacent the first tube, and securing the second end of the connector in the inlet of the second tube, thereby providing a flow path through all the tubes for heat exchange fluid. Such a system according to the present invention may have one or some (in any possible combination) of the following: wherein each tube has a tube wall thickness, each connector has a connector wall thickness, and the connector wall thickness is greater than the tube wall thickness; wherein the connector wall thickness is about 120% larger than the tube wall thickness; and/or wherein there is a space between the exterior of the connector ends and the interior of the tube ends and the method further including securing the connector ends in tube ends with flame-applied securement material so that the flame-applied securement material encompasses the ends of the connectors within the ends of the tubes and the securement material substantially fills space between the exterior of the ends of the connectors and the interior of the ends of the tubes.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112. The inventors may rely on the Doctrine of Equivalents to determine and assess the scope of their invention and of the claims that follow as they may pertain to apparatus not materially departing from, but outside of, the literal scope of the invention as set forth in the following claims. All patents and applications identified herein are incorporated fully herein for all purposes. It is the express intention of the applicant not to invoke 35 U.S.C. §112, paragraph 6 for any limitations of any of the claims herein, except for those in which the claim expressly uses the words ‘means for’ together with an associated function. In this patent document, the word “comprising” is used in its non-limiting sense to mean that items following the word are including, but items not specifically mentioned are not excluded. A reference to an element by the indefinite article “a” does not exclude the possibility that more than one of the element is present, unless the context clearly requires that there be one and only one of the elements.

What is claimed is:

1. A heat exchanger comprising
a plurality of tubes, each tube of the plurality of tubes comprising a heat exchange tube, the tubes adjacent each other, each tube in fluid communication with at least one adjacent tube so that heat exchange fluid is flowable through all the tubes,
a plurality of heat exchange fins connected to the plurality of tubes,
each tube of the plurality of tubes having an inlet with an inlet end and an outlet with an outlet end,
a plurality of connectors, each pair of adjacent tubes comprising a first tube and a second tube and a connector connecting the outlet of the first tube to the inlet of the adjacent second tube providing fluid communication between the first tube and the second tube,
the inlet end and outlet end of each tube comprising a substantially straight tube portion of substantially constant inner diameter and of substantially constant outer diameter, the inner diameters of the inlet end and the outlet ends substantially equal,
each connector having a first end sealingly secured within the outlet end of its corresponding first tube and a second end sealingly secured within the inlet end of its corresponding second tube, and
each connector having an outer diameter less than the inner diameter of the tubes' inlet ends and less than the inner diameter of the tubes' outlet ends.

2. The heat exchanger of claim 1 wherein each inlet end and each outlet end has an end flared portion to facilitate entry therein of an end of a connector.

3. The heat exchanger of claim 1 wherein the tubes and the connectors are made of the same material.

4. The heat exchanger of claim 3 wherein the material is one of copper, steel, stainless steel, or aluminum.

5. The heat exchanger of claim 1 wherein the tubes and connectors are made of different materials.

6. The heat exchanger of claim 5 wherein the tubes mare made of copper and the connectors are made of aluminum.

7. The heat exchanger of claim 1 wherein the connectors are U-bend connectors.

8. The heat exchanger of claim 1 wherein the ends of the connectors fit tightly into the ends of the tubes without distortion of the ends of the connectors.

9. The heat exchanger of claim 1 wherein
each tube has a tube wall thickness,
each connector has a connector wall thickness, and
the connector wall thickness is substantially equal to the tube wall thickness.

10. The heat exchanger of claim 1 wherein the
each tube has a tube wall thickness,
each connector has a connector wall thickness, and
the connector wall thickness is greater than the tube wall thickness.

11. The heat exchanger of claim 9 wherein the connector wall thickness is about 120% larger than the tube wall thickness.

12. The heat exchanger of claim 1 wherein
each end of each connector is secured within an end of a tube with flame-applied securement material.

13. The heat exchanger of claim 12 wherein the flame-applied securement material is solder.

14. The heat exchanger of claim 12 wherein the flame-applied securement material encompasses the ends of the connectors within the ends of the tubes.

15. The heat exchanger of claim 14 wherein the securement material substantially fills space between the exterior of the ends of the connectors and the interior of the ends of the tubes.

16. A heat exchanger comprising
a plurality of tubes comprising a first tube, at least one intermediate tube, and a last tube, each tube of the plurality of tubes comprising a heat exchange tube, the tubes adjacent each other, each tube in fluid communication with an adjacent tube or tubes so that heat exchange fluid is flowable through the first tube then through intermediate tubes to the last tube,
a plurality of heat exchange fins connected to the tubes of the plurality of tubes,
each tube of the plurality of tubes having an inlet end and an outlet end,
a plurality of connectors, each pair of adjacent tubes connected with a connector connecting an outlet of one tube to an inlet of an adjacent tube providing fluid communication therebetween,
each tube having a tube wall thickness,
each connector having a connector wall thickness, and
the connector wall thickness greater than the tube wall thickness.

17. A method for making a heat exchanger, the heat exchanger comprising a plurality of tubes, each tube of the plurality of tubes comprising a heat exchange tube, the tubes adjacent each other, each tube in fluid communication with an adjacent tube or adjacent tubes so that heat exchange fluid is flowable through a first tube then through intermediate tubes to a last tube, a plurality of heat exchange fins connected to the tubes of the plurality of tubes, each tube of the plurality of tubes having an inlet end and an outlet end, a plurality of connectors, each pair of adjacent tubes comprising a first tube and a second tube and a connector connecting an outlet of each first tube to an inlet of each adjacent second tube providing fluid communication between the first tubes and the second tubes, the inlet and outlet of each tube comprising a substantially straight tube portion of substantially constant inner diameter and of substantially constant outer diameter, the inner diameters of the inlet and the outlet substantially equal, the connector having a first end sealingly secured within the outlet of the first tube and a second end sealingly secured within the inlet of the second tube, and the connector having an outer diameter less than the inner diameter of the inlet and less than the inner diameter of the outlet, the method including
for each pair of adjacent tubes
inserting a first end of each connector into an outlet of a first tube and securing the first end of the connector in the outlet of the first tube, and
inserting a second end of each connector into an inlet of a second tube, the second tube adjacent the first tube, and securing the second end of the connector in the inlet of the second tube, thereby providing a flow path through all the tubes for heat exchange fluid.

18. The method of claim 17 wherein
each tube has a tube wall thickness,
each connector has a connector wall thickness, and
the connector wall thickness is greater than the tube wall thickness.

19. The method of claim 18 wherein the connector wall thickness is about 120% larger than the tube wall thickness.

20. The method of claim 17 wherein there is a space between the exterior of the connector ends and the interior of the tube ends and the method further comprises
securing the connector ends in tube ends with flame-applied securement material so that the flame-applied securement material encompasses the ends of the connectors within the ends of the tubes and the securement material substantially fills space between the exterior of the ends of the connectors and the interior of the ends of the tubes.
